(19) United States
(12) Patent Application Publication
(10) Pub. No.: US 2003/0180415 A1
(43) Pub. Date: Sep. 25, 2003

(54) High protein concentrate from cereal grain and methods of use thereof

(76) Inventors: Michael J. Stiefel, Panora, IA (US); Jerry F. Strissel, Harlan, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/274,762

(22) Filed: Oct. 21, 2002

Related U.S. Application Data
(60) Provisional application No. 60/351,953, filed on Mar. 20, 2002.

(51) Int. Cl. A23L 1/10

(52) U.S. Cl. 426/18

(57) ABSTRACT

A highly-digestible, high protein concentrate for feeding operations obtained by a modified method of dry milling corn using specific dry milling at the beginning of the ethanol process.

### BIBLIOGRAPHY

The publications and other material used herein to illuminate the background of the invention or provide additional details respecting the practice, are herein incorporated by reference in their entirety, and for convenience are respectively grouped in the appended Bibliography.

### BACKGROUND OF THE INVENTION

Feeds for culturing monogastric animals essentially contain agricultural and aquatic products such as corn, fish meal, or the like. The production of these agricultural and aquatic products fluctuates from year to year depending upon the weather and other factors influencing the size of harvests and catches, whereby it has been difficult to obtain a stable supply of feed. Consequently there have been attempts to use synthetic compounds instead of natural agricultural and aquatic products as part of the feeds.

Feed grains which are required in livestock industries such as pigs, chicken, cattle raising, and dairy farming have been imported from overseas in large quantities. In place of feed grains, attempts have been made to use fermented formula feeds by-products, however, these by-products contain phytin, and it is known that the utilization and absorbability of phosphate in phytin which is incorporated in feeds is relatively poor. Therefore, one of the problems associated with the use of grain and oilseed products in feed for monogastric animals, e.g. pigs, chickens, and fish, is the presence of phytate. Phytate phosphorus is nutritionally unavailable, and is excreted in the feces. It is then suspected of contributing to nutrient enrichment of several ecosystems when manure from confined animal rearing operations leaches into the ground and from there into lakes, streams, and bays.

Fish meal has been the main protein source used in feeds for farmed carnivorous fish since fish farming began. It also is a protein source for other monogastric animals. Fish meal is produced from stocks of fish not harvested for human consumption. Periodically, ocean temperatures and currents cause the fish stock to move offshore, out of reach of the fishery. Consequently, the world production of fish meal declines and the cost increases, almost doubling its lowest value. When such occurrences arise, feed producers turn to alternate proteins, such as rendered products and protein concentrates from grains and oilseeds. Yellow corn gluten meal has been evaluated as a fish meal substitute for fish with moderate success. Weede (1997) found that corn gluten could substitute for 25% of the fish meal in feeds for rainbow trout, but that 50% substitution or higher resulted in reduced feed intake and growth. Skonberg et al. (1998) reported that use of over 15% corn gluten meal in trout feeds caused a yellowing of the flesh. As a result, most trout feed manufacturers limit corn gluten meal to 5% in feeds or avoid it altogether. Corn gluten protein is reported to be relatively well digested by rainbow trout and Pacific salmon, but phosphorus availability is low (Sugiura et al., 1998), likely the result of phytate. Thus, what limits the use of corn gluten meal in feeds for salmonoids and shrimp is the presence of xanthophylls pigments and phytate.

Yellow corn gluten meal is derived from the wet-milling process of corn. The primary products from the wet-milling process are food and industrial starches and sweeteners. Co-products include corn oil and the feed products corn gluten feed (CGF), corn gluten meal (CGM), corn germ meal, and condensed fermented corn extractives (steep liquor). The germ is solvent-extracted to recover oil, and the extracted germ meal is used in feed products. The gluten is separated from starch by centrifuges, giving a stream containing 69-72% (dry substance bases) total protein, which is dried to become 60% protein CGM. It is highly digestible, contains metabolizable energy (ME) of 4,131 kcal/kg of dry matter for the chick, and is a rich source of available carotenes (49-73 mg/kg) and xanthophylls (244-550 mg/kg, dry substance basis). Its crude protein is highly digestible, a good source of methionine and cystine, but very low in lysine and tryptophan.

However, in traditional wet milling, the germ is exposed to sulfur dioxide for extended periods of time, which can affect the quality of the oil. Moreover, this exposure to sulfur affects corn gluten meal and corn germ meal because of the high sulfur content occurring, which can be deleterious. The “Quick Germ” process results in a germ that has not been exposed to sulfite or other chemicals. While conventional dry milling also recovers germ without exposing the germ to sulfur dioxide, the process results in considerable broken germ, and the oil content of the recovered germ fraction is low (approximately 20%) due to the incomplete separation of endosperm and pericarp from the germ.

Corn milling processes are employed to separate corn into various components of the corn kernel. The mature corn kernel has four easily separable parts: tip cap, pericaip, endosperm and germ. The major component of corn is starch, of which 98% is in the endosperm (Earle et al., 1946). On the whole kernel basis, starch content is 72-73%. The endosperm also contains 74% of the kernel protein, of which the majority is insoluble storage proteins.

The germ is the major depository of lipids, which amount to 83% of the total kernel lipids. The greater parts of the germ lipids are triacylglycerides, which, on extraction, give the well-known corn oil of commerce. The germ, being potentially metabolically active tissue, contains 70% of the kernel sugar and 26% of the kernel protein. Most of the germ proteins are albumins or globulins and probably are components of the enzymatic apparatus of the cells.

The corn germ is also rich in mineral elements that are essential for early growth of the embryo. The embryo contains 78% of the kernel minerals of which inorganic phosphorus is the most abundant. It is largely present as the potassium-magnesium salt of phytic acid—the hexaphosphate ester of inositol. Phytin is an important storage form of phosphorus (Hamilton et al., 1951; O'Dell et al., 1972), which is liberated by phytase enzymes to initiate embryo development. More than 80% of the phosphorus in corn is in the form of phytate. The corn germ contains nearly 90% of the phytate present in whole corn.

Corn kernels can differ significantly in color from white to yellow, orange, red, purple, and brown. Color differences may be due to genetic differences in pericarp, aleurone, germ, and endosperm (Neuffer et al., 1968). The pericarp can be colorless, orange, cherry red, red, dark red, brown, or variegated; the aleurone layer can be colorless, red, red-purple, purple, or brown; the germ can be colorless, yellow, orange-red, or purple; the endosperm is either colorless, yellow, orange, or orange-red (Wolf et al., 1952a).

There are three corn processes commercially in use today: dry grind ethanol, corn wet milling and dry milling. Of these three, dry grind ethanol and corn wet milling are used to produce ethanol from corn. A fourth process, modified dry grind ethanol, is a recently developed process using a combination of dry grind ethanol and corn wet milling methodology. All four processes generate an array of co-products that have varying degrees of separation of the corn kernel's constituents of starch, protein, fiber and oil.

The five basic steps in the conventional dry grind ethanol process are grinding, cooking, liquefaction, saccharification and fermentation. Whole corn kernels are first ground with typically either hammer mills or roller mills. The particle size influences cooking hydration and subsequent enzymatic conversion. The milled corn is mixed with water, making 22 gallons of mash from a bushel of corn (Singh 1998). After cooking at 320° F., the mash is cooled to 145° F. and mixed with fungal amylase. The role of the alpha-amylase enzymes in the initial steps of conversion is to decrease the viscosity of a gelatinized starch. This thinning and liquefaction activity produces only dextrins as the reaction products. The mixture is transferred to saccharification reactors, maintained at 104° F., where the starch is converted by saccharifying enzymes to the fermentable sugars glucose or maltose. The converted mash is cooled to 84° F. and fed to fermentation reactors where fermentable sugars are converted to ethanol and CO₂ by the use of selected strains of Saccharomyces yeasts.

The resulting beer is flashed to separate the carbon dioxide from the ethanol. The resulting liquid is fed to a recovery system consisting of two distillation columns and a stripping column. The 95% ethanol stream is transferred to a molecular sieve where the remaining water is removed using adsorption technology. Purified ethanol, denatured with a small amount of gasoline, produces fuel grade ethanol. Another product is produced by distilling 95% ethanol to remove impurities, resulting in 99.95% ethanol for non-fuel uses.

Whole stillage withdrawn from the bottom of the distillation unit is centrifuged to produce distillers wet grains (DWG) and thin stillage. DWG leaves the centrifuge at 55-65% moisture, and is either sold wet as a cattle feed or dried to produce an end-product of about 10% moisture and approximately 30% protein called distillers dried grains (DDG). Using an evaporator, thin stillage is concentrated to form distillers solubles, which is added to the distillers grains process stream and dried to 88% dry matter. This product is marketed as distillers dried grains with solubles (DDGS). Nearly 30% of the original corn kernel (oil, protein, minerals and cell structure) is not fermentable to ethanol and ends up as DDGS.

The conventional dry grind ethanol process has a relatively low capital cost and produces low value co-products, i.e., distiller's dried grain with solubles (DDGS), distiller's dried solubles (DDS), and dried distiller's grains (DDG). DDG contain most of the water-insoluble nutrients in the original corn except for starch, which has been removed during the fermentation. The content of the crude protein, fat, and fiber are higher than that in corn gluten feed (CGF). No starch or soluble solids are present, but as in CGF, the hemicelluloses, cellulose, and insoluble proteins still remain. The composition of the fat remains essentially that of corn because corn oil is not recovered. The amino acid pattern generally reflects the corn source. DDG is a good source of B-vitamins, some of which have been generated by the yeast during fermentation. In addition, yeast also contributes 1 to 2 lbs. of available protein and is a source of nucleotide material, which can have health benefits.

The mineral content of DDG is low because it does not contain the solubles. The phosphorus in DDG is present primarily in the phytin form. However, it has been reported that considerable amounts of the phosphorus in condensed distiller's solubles is highly available (Nelson et al., 1968). The availability of phosphorus in DDGS is increased substantially because the solids from distiller's solubles are added back and dried on the insoluble DDG. The phosphorus is found to be 43% available in DDGS and 93% available in condensed distiller's solubles. During the fermentation process, the yeast apparently provides the enzyme phytase in sufficient quantities to hydrolyze the soluble phytin to an inorganic, available form of phosphorus.

In 1985, Y. V. Wu, K. R. Sexson, and A. A. Lagoda evaluated corn grits, flour, degerminator meal, and hominy feed from corn dry-milling for fermentation to produce ethanol. The residues, after ethanol was distilled, were fractionated into distillers' grains, centrifuged solids, and stillage soluble. Corn grits distillers' grains had 68% protein and accounted for 49% of the fermentation residue. Lysine was considerably enriched in degerminator meal, hominy feed, and their fermentation products compared to that in grits, flour, and their distillers' grains.

A sequential extraction process for corn milling was developed to produce higher value co-products (Chang et al., 1995). Oil yield and quality are enhanced by the process since the entire kernel is extracted. Yields are enhanced in different amounts depending on the source of corn (dent or high lysine) (Hojilla-Evangelista et al., 1992a). The protein resulting from the product has a higher quality due to the elimination of the need to steep in sulfur dioxide. Freeze-dried protein concentrates containing nearly 80% protein, compared to 60-62% for corn gluten meal, were produced. The protein was found to have a mild corn flavor, excellent emulsifying capacity and emulsion stability, and good heat stability (Myers et al., 1994). The starch remaining from the process was of lower quality than that resulting from conventional wet milling, but was still an excellent substrate for ethanol production.

The “Quick Germ” method, a modified dry grind ethanol process to increase the value and quantity of co-products made from a dry grind ethanol process utilizes some of the wet mill technologies to separate the germ and fiber from the seed. In this process, the corn kernel is soaked in water for 8-12 hours and then lightly ground in a conventional Bauer mill. Germ and fiber are recovered using conventional hydrocyclone technology that is used in the corn wet milling industry. This process separates the germ (Singh and Eckhoff, 1997) and fiber (Wahjudi et al., 2000) using the principles of density difference and hydrodynamics; germ and fiber are lighter after soaking and flow out the overflow of the hydrocyclone, while the starch and protein flow out the underflow. Germ and fiber are washed, dewatered and dried; fiber is aspirated to separate fiber and germ. The rest of the kernel is not prepared for separation, but can be milled to a fine consistency. This mash can be jet cooked, liquefied, saccharified, and fermented as conventionally done in a dry grind plant.

The fiber recovery process has several advantages compared to the conventional dry grind ethanol process. It increases fermentor capacity 6-8%. The concentration of protein in DDGS is increased as fiber is decreased and enhances the potential for including DDGS in nonruminant livestock diets.

In comparison to other cereal gains, high levels of cholesterol lowering phytosterol components, ferulate phytosterol esters (FPE), free phytosterol and phytosterol fatty acyl esters, can be extracted from pericarp fiber (Moreau et al., 1999). Compared with other cholesterol lowering edible oil supplements, corn fiber oil extracted from corn fiber is the only product that contains three different classes of natural cholesterol lowering compounds.

Accordingly, a need exists in feeding operations for a high protein source particularly useful in applications where a highly digestible protein source with increased availability of phosphorus, increased lysine, and the presence or absence of xanthophyll pigments is found, wherein the absence of xanthophyll is required depending on which monogastric is being found and/or what product is desired at the end of the fermentation process, and which is commercially feasible using a current, modified dry-milling ethanol production system.

### BRIEF SUMMARY OF THE INVENTION

This invention is directed to a novel, alternative protein source in feeding operations and a method for manufacture thereof, derived from a modified method of dry milling of corn using specific dry milling equipment at the beginning of the ethanol process comprising tempering corn in water, and passing the corn through the milling equipment. The fractions of the corn are collected wherein one fraction is the grits and the other is the thrus. The thrus can be dried to form hominy. The grits are sent through a normal grinding and ethanol fermentation process with the main products being ethanol and a high protein concentrate. Use of the grit portion in the fermentation process gives the process 10%-30% more volume than originally built to process.

A principal object of this invention is to provide a high protein concentrate having a protein content greater than 50%, an oil content in the range of about 4 to 6%, a starch content of about less than 1%, acid detergent fiber (ADF) of about 2%-3%, preferably, 1.5% to about 2.5%, and a lysine value of about 1% to 2%, but preferably, 1%-1.75%. Additionally, if desired, the high protein concentrate may also have a xanthophyll content of less than about 80 mg/kg and a beta-carotene content of less than about 3 mg/kg.

Another object of this invention is to provide a commercially feasible modification of the current dry milling ethanol production system in which the corn kernel is separated into specified fractions prior to entering the normal ethanol process.

A still further object of the invention is directed to an animal feed containing from up to about 80% high protein concentrate, however preferably containing from about 40% to about 65%.

These and other features, aspects, and advantages of the present invention will become better understood with reference to the following description, drawings, and attached claims below.

### BRIEF DESCRIPTION OF THE DRAWINGS

FIG. 1 shows a flow diagram for basic ethanol production.

FIG. 2a shows dry milling ethanol production where the thrus is separated and sent to the oven and dried to form hominy.

FIG. 2b shows dry milling ethanol production where the grits are sent to the normal grinding and ethanol fermentation process with the main products being ethanol and a high protein concentrate.

FIG. 3a,b,c shows dry milling ethanol production where the thrus are sent to a secondary fermentation unit to produce ethanol and the grits are sent to the normal grinding and ethanol fermentation process with the main products being ethanol and a high protein concentrate.

FIG. 4a,b,c shows dry milling ethanol production where the thrus are first subjected to oil extraction, and then to ethanol fermentation and the grit portion is sent to the normal grinding and ethanol fermentation process with the main products being ethanol and a high protein concentrate.

FIG. 5a,b,c shows dry milling ethanol production where the thrus are subjected to oil extraction with the spent material being screened and aspirated for the fiber which is used for DDGS. The grit portion is sent to the normal grinding and ethanol fermentation process with the main products being ethanol and high protein concentrate.

FIG. 6a shows dry milling ethanol production where the tails are passed through a roller mill, then sifted through a screen, followed by an aspirator and gravity table.

FIG. 6b shows that the grit portion goes into production of ethanol and high protein concentrate.

FIG. 7a,b,c shows dry milling ethanol where the grain is treated similarly as shown in FIG. 6a,b except the hominy is converted to ethanol by a secondary fermentation.

FIG. 8a,b,c shows dry milling ethanol production where the thrus from the sifting screen, aspirator, and gravity table are collected for solvent extraction of the oil, and the remaining spent material is taken forward to ethanol fermentation.

FIG. 9a,b,c shows dry milling ethanol production where the corn oil is extracted from the fiber and germ, and the fiber is saved as a separate entity and the grits goes into production of ethanol and a high protein concentrate and the hominy is directed towards ethanol and soluble protein end products.

### DETAILED DESCRIPTION OF THE INVENTION

The following definitions are used herein.

Beta-carotene content: The total amount of beta-carotene. Beta-carotene has a 40-carbon base, and is the dominant provitamin A carotenoid in corn.

Corn Gluten Feed (CGF): A feed ingredient with a medium protein level and is palatable to all classes of livestock and poultry. CGF does not contain any gluten. It is comprised of the fiber fraction (bran), steep liquor, and, where available, germ meal. It commonly contains a minimum of 21% crude protein and approximately 15% starch.

Corn Gluten Meal (CGM): A feed ingredient that is the dehydrated protein stream resulting from starch separation in the endosperm fraction of the grain. It has a high nutrient density and usually is sold containing a minimum of 60% total protein. It is highly digestible, and is a rich source of carotenes (49-73 mg/Kg) and xanthophylls (244-550 mg/Kg).

Crude Protein Content: The total nitrogenous material in the plant substance. Protein=N×6.25.

Distillers' Dried Grains (DDG): DDG contain most of the water-insoluble nutrients in the original corn except for starch, which has been removed during fermentation for the production of alcohol. The content of crude protein, fat, and fiber are higher than that in CGF. Crude protein content of the DDG is approximately 28%-30%.

Distillers' Dried Grains with Solubles (DDGS): DDG plus solubles from the corn fermentation ethanol process.

Distillers' Dried Solubles (DDS): The liquid fraction that is separated from the solid residue, evaporated, and dried following fermentation of corn for ethanol production. It contains 28.5% protein, 9% fat, and 7% ash.

Dry Substance Basis (DSB): Measurements are based on a zero moisture content basis.

Xanthophyll Content: The total amount of yellow carotenoid pigment.

The present invention offers a novel means of commercializing the production of a new high protein concentrate by incorporating the use of specific dry milling equipment in front of current ethanol production equipment.

The high protein concentrate of the present invention offers novel characteristics which are particularly useful as an alternate protein source in feeding operations that need a highly digestible protein source with increased availability of phosphorus, increased lysine, and the absence of xanthophyll pigments. One example of a feeding operation that could use this material is aquaculture. Currently, there are no commercial feeding operations using this source of material.

Although the uses of the present invention have been disclosed primarily with respect with feeds for aquaculture, this is not deemed to limit the scope of this invention. The present invention may be used in other feeding operations where alternate protein sources are needed.

The invention includes the use of a new ingredient, a high protein concentrate, in feeding operations to replace other protein sources. More specifically, the high protein concentrate can be used to replace fish meal as an alternate protein source, and used to enhance the development of white fish fillets verses the yellow pigmented fillets wherever yellow gluten is used at levels greater than 15% or as a replacement or substitute of corn gluten meal because of the absence of sulfur, which makes it more palatable and its benefit as a source of nucleotides.

Previously, various wet milling applications have been used to separate the germ grits, and fiber. The development of a high protein concentrate is the result of separating the corn kernel into separate entities prior to processing for ethanol using two specific pieces of dry milling equipment available from Satake USA Inc., Houston, Tex. The first machine is a Satake maize Degermer VBF which consists of vertical series of screens and a two piece degerming roll. This mill and its operations are described in U.S. Pat. No. 5,295,629. Degermers are well known to those skilled in the art, and therefore a detailed disclosure of such equipment is not provided. However, a degermer has the features of air pressure, screen grain or grain dehuller and corn degermer. Many types of degenninators may be used, such degerminators from the Beall Corp. (Illinois), Ocrim Corp. (Italy), and Bühler (Germany), which all do the same thing. The degerminator fractures the corn kernels into their constituent—endosperm (also known as grit), germ, and hull (also known as bran). The hull is substantially removed such as with a pneumatic cleaner or aspirator, for example.

The second machine is called a Satake KB Rice Polisher which utilizes a series of horizontal screens which is capable of removing the pericarp from grain. This machine and its operation is described in U.S. Pat. No. 4,515,075. The chamber of configuration helps ensure that each individual grain is gently milled by the friction action between other corn kernels in the chamber. Timing of exposure, revolution of the milling rotor, size of screen, and amount of pressure on the corn itself all must interact properly in order to produce the desired amount of milling.

In all cases, the corn is tempered with water to about a 20% to about 25% moisture level prior to running through the milling equipment. The fractions of corn that are collected after running it through the VBF or the KB consist of the grits and thrus. Each fraction is weighed and recorded. The thrus that are collected are further processed at a milling laboratory. The grits are collected and processed further through fermentation.

White grits fermented with the remaining solids were dried and analyzed for protein, amino acids, minerals, fat, fiber, and ash. The results are presented in Table 1 along with a comparison to the standard DDG that is normally produced in ethanol production. It should be appreciated that embodiments of the invention are not limited to white corn as other colors of corn, such as yellow, blue and red give a similar profile.

TABLE 1
Analysis of white high protein concentrate

| | White High Protein | |
|---|---|---|
| Component^{a} | Concentrate | Standard DDG^{b} |
| Protein | 63.6 | 29.2 |
| Crude Fat/Oil | 7.7 | 8.2 |
| Crude Fiber | 4.7 | 13.8 |
| Ash | 1.7 | 2.2 |
| Calcium | 0.03 | 0.05 |
| Phosphorus | 0.30 | 0.40 |
| Tryptophan | 0.40 | 0.22 |
| Cystine | 1.14 | 0.22 |
| Methionine | 1.31 | 0.54 |
| Aspartic Acid | 4.08 | 1.82 |
| Threonine | 2.35 | 0.97 |
| Serine | 3.17 | 1.08 |
| Glutamic Acid | 13.05 | 4.32 |
| Proline | 6.11 | 2.81 |
| Glycine | 1.90 | 1.08 |
| Alanine | 5.01 | 2.16 |
| Valine | 3.13 | 1.41 |
| Isoleucine | 2.49 | 1.08 |
| Leucine | 9.23 | 3.24 |
| Tyrosine | 2.40 | 0.86 |
| Phenylalanine | 3.38 | 1.30 |
| Lysine | 1.51 | 0.65 |
| Histidine | 1.74 | 0.65 |
| Arginine | 2.23 | 1.18 |

^{a}All values based on a dry substance basis, %
^{b}Source: Corn Chemistry and Technology, Stanley A. Watson and Paul E. Ramstad, 1987.

The protein level of the high protein concentrate makes it a competitor to corn gluten which typically averages 60%-62% protein. One advantage of a white hybrid is its use as a protein source in aquaculture feed applications where very low levels of xanthophyll pigment is desired. While this high protein concentrate could also be used as a replacement for fish meal in aquaculture feed with the additional benefit of having much lower phosphorus content than fish meal, it can also be used in other feeding operations where alternate protein sources are needed. Moreover, white, yellow, red, or blue corn can be used as the source. Additional benefits of this high protein concentrate are: (1) greater digestibility; (2) no exposure to sulfur which makes it more palatable; (3) and yeast, which serves not only as a protein source but also as a source of nucleotides.

The use of the dry milling equipment (Satake VBF or KB) in an ethanol production plant offers an economically feasible solution to adding value to the resulting co-products. There are several stages or options of incorporating the changes into an ethanol plant. The options all have an impact on a material balance sheet, plant efficiency, and on the added value of the co-products. The options are best presented in the form of examples for both the VBF and KB embodiments. Each example results in a material balance, which indicates potential added value.

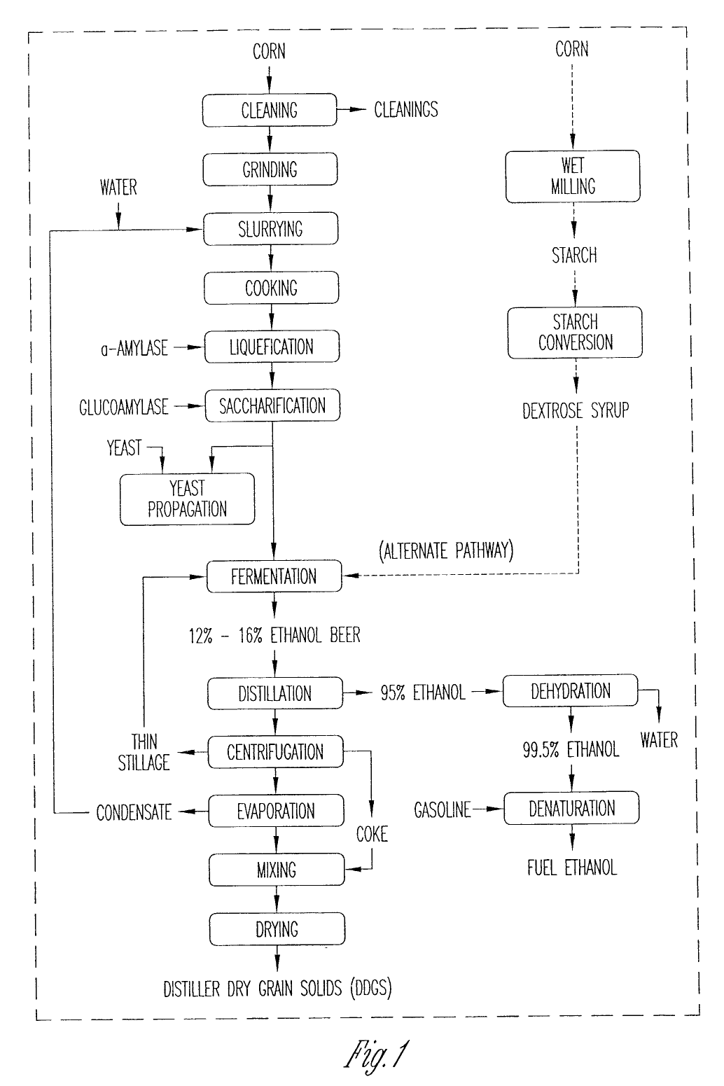

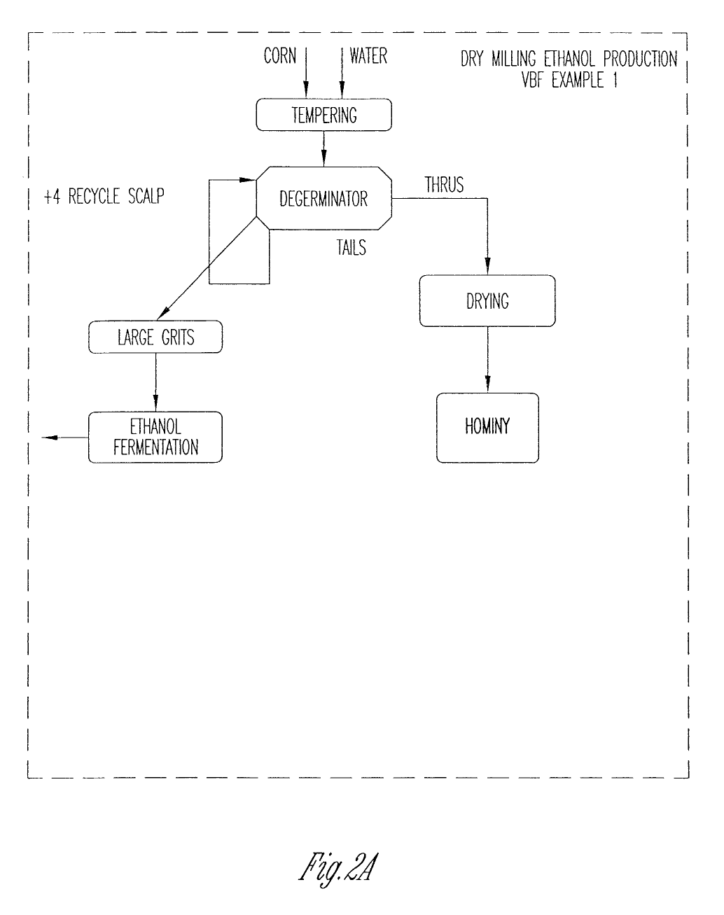

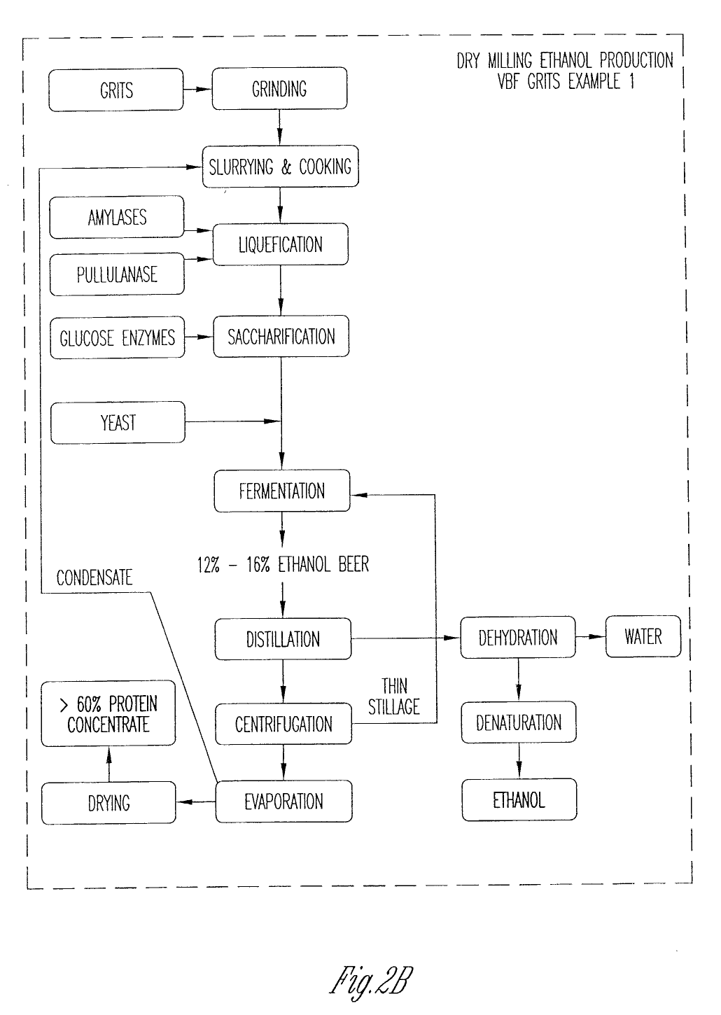

A standard flow diagram for ethanol production is represented in FIG. 1.

### EXAMPLES

The following example serves to better illustrate the invention described herein and are not intended to limit the invention in any way. Those skilled in the art will recognize that there are several different parameters which may be altered using routine experimentation and which are intended to be within the scope of this invention.

It should be appreciated that the process for creating a high protein concentrate all begin by placing dry milling equipment at the front end of the ethanol process.

The embodiment of the first four examples described depend upon placing a Satake Maize Degermer VBF at the beginning of the process.

### Example 1

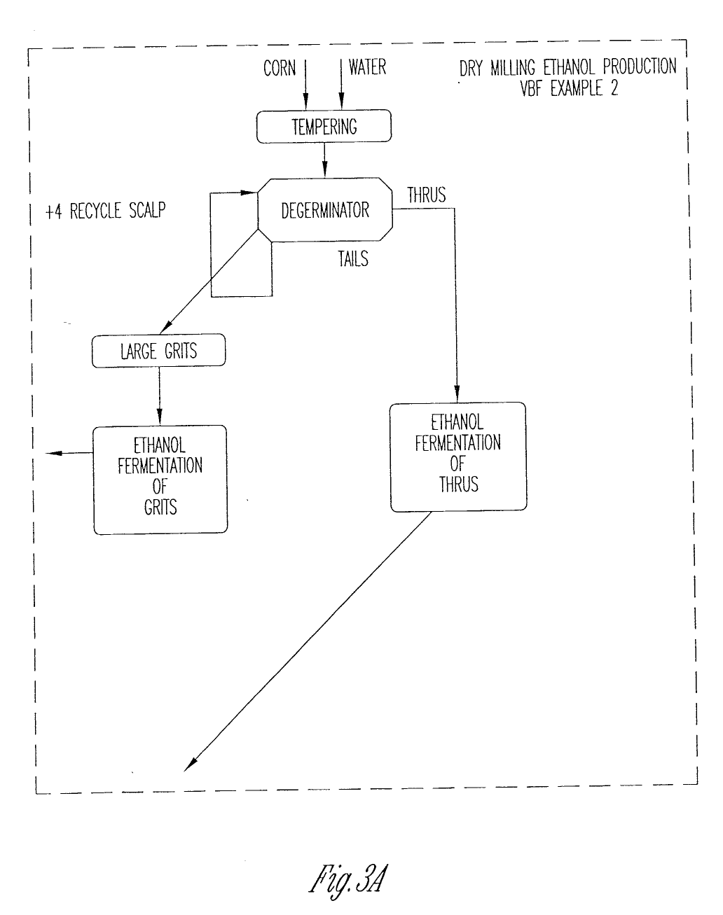

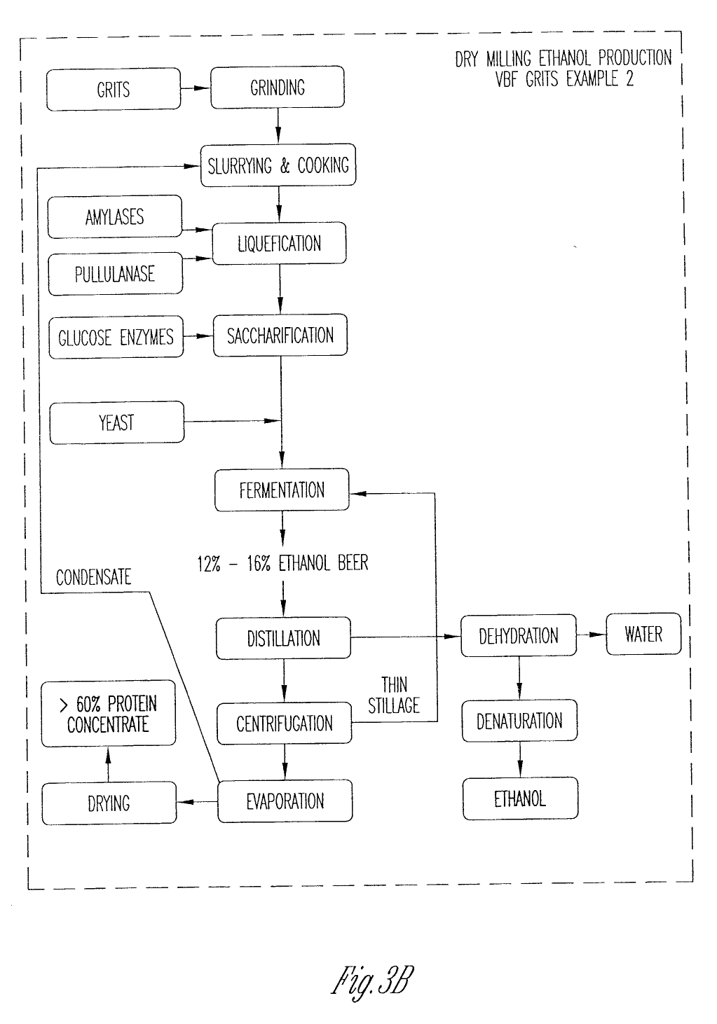

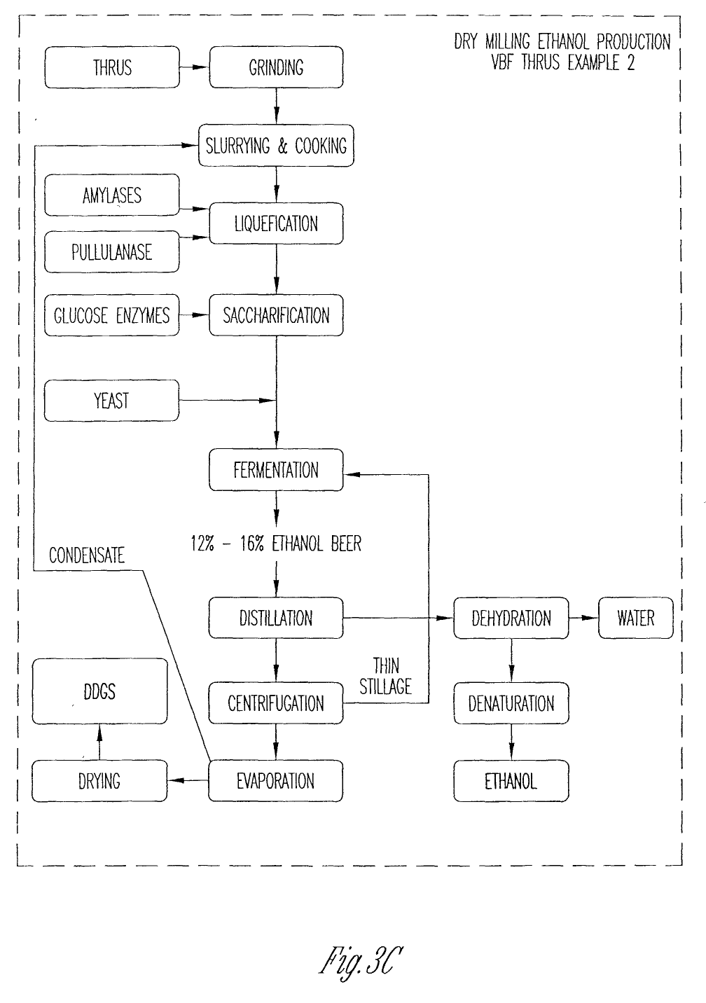

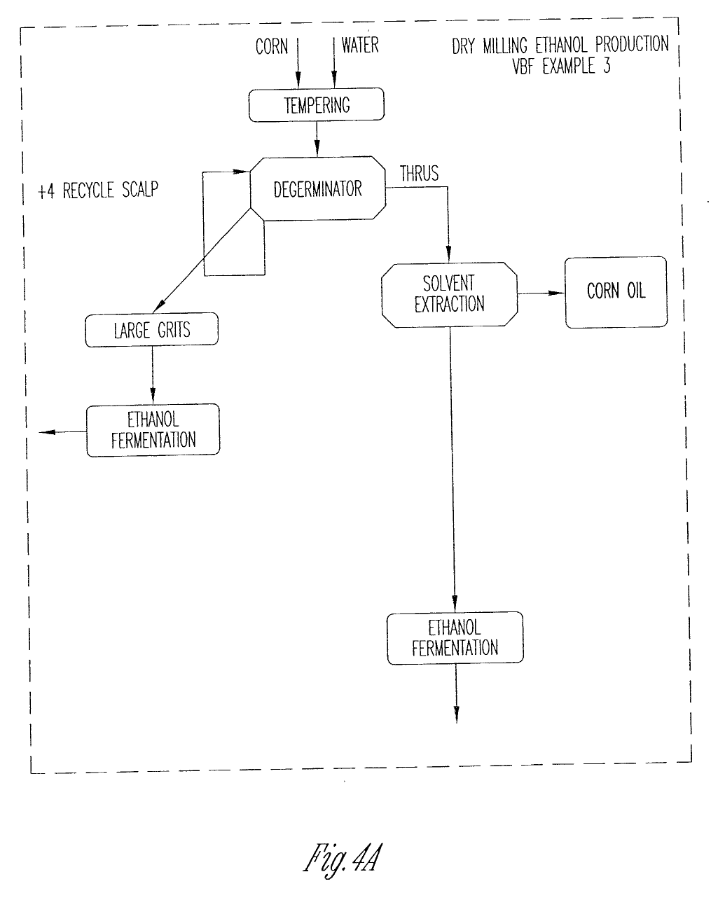

In VBF Example 1 (FIG. 2a,b), the corn is first tempered, and then passed through the VBF machine. The thrus are separated and sent to the oven where they are dried to form hominy (FIG. 2a). The grits are sent to the normal grinding and ethanol fermentation process with the main products being ethanol and a high protein concentrate (FIG. 2b).

### Example 2

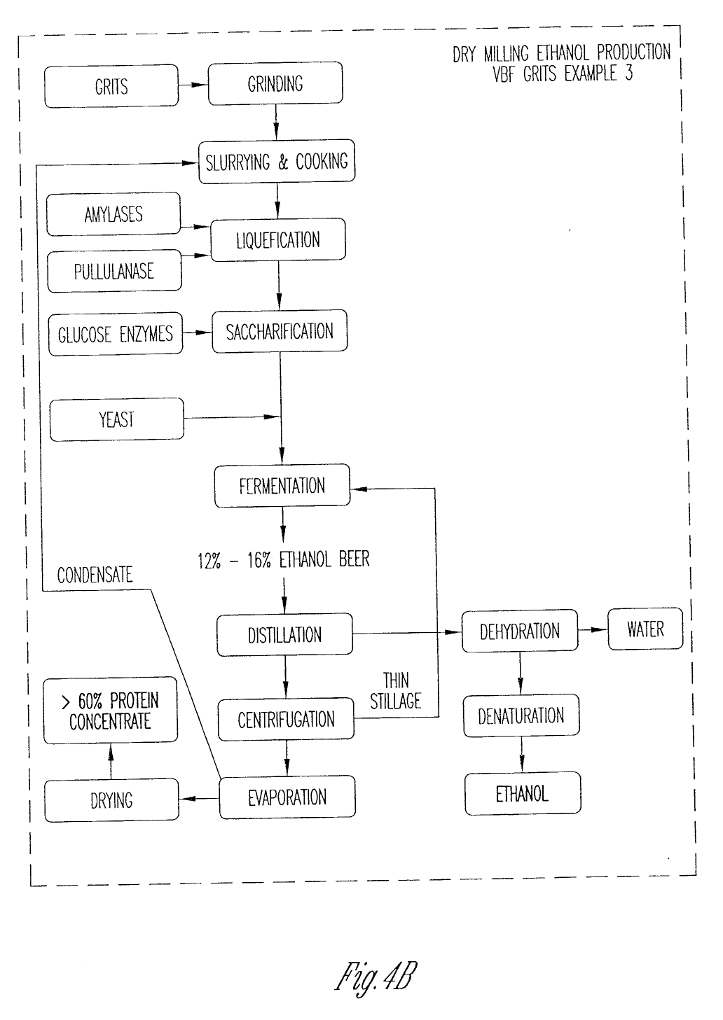

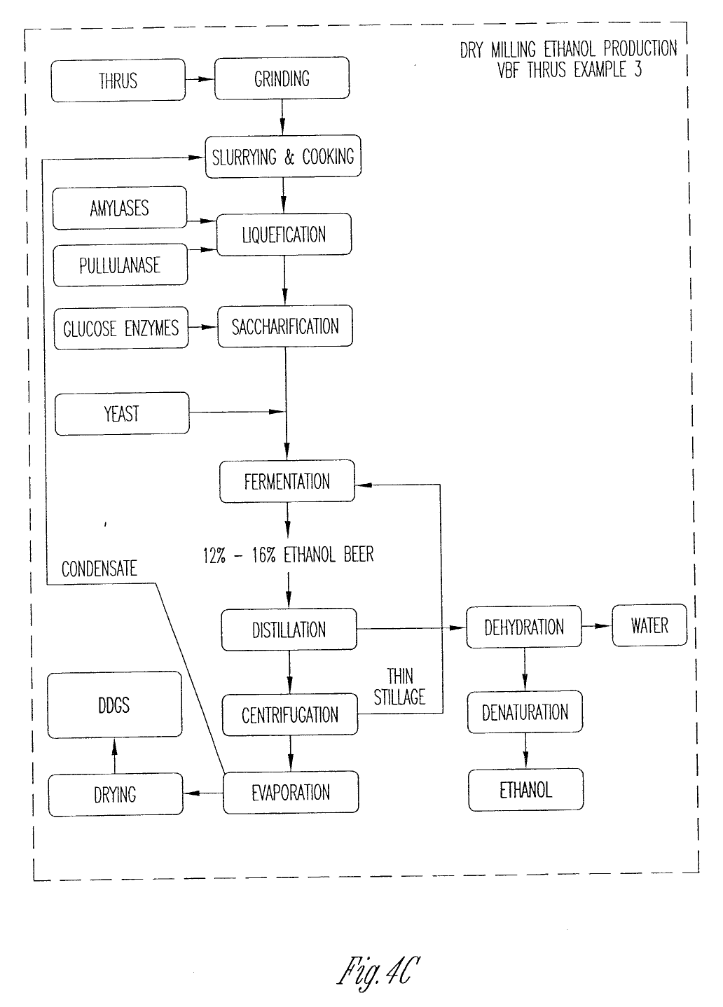

In VBF Example 2 (FIG. 3a,b,c), the corn is tempered, and then passed through the VBF. The thrus are sent to a secondary fermentation unit to produce ethanol. The grits are treated the same as in Example 1 where they are used to make ethanol and a high protein concentrate.

### Example 3

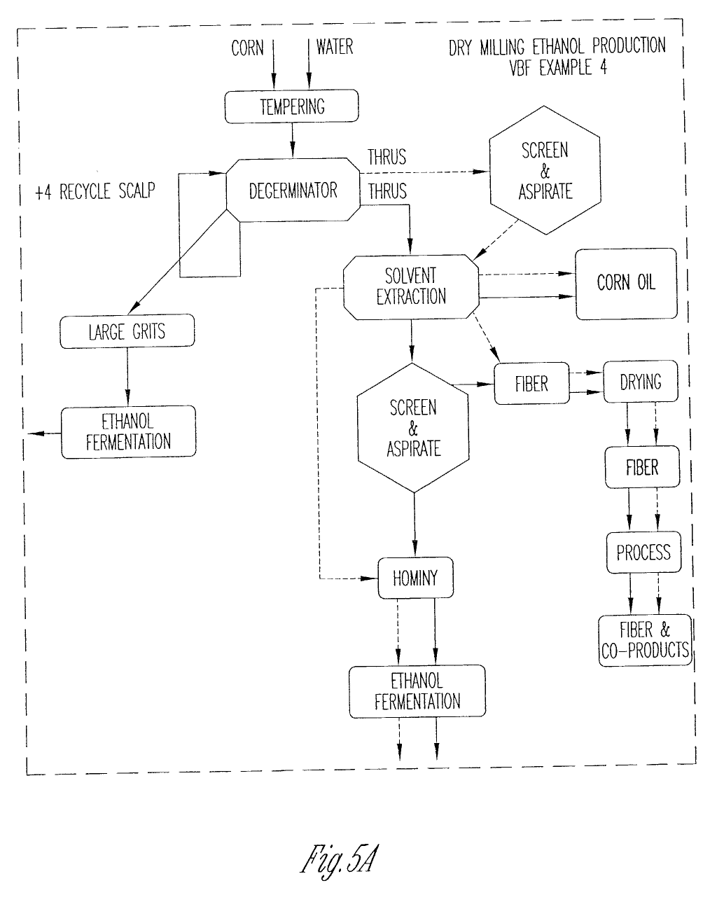

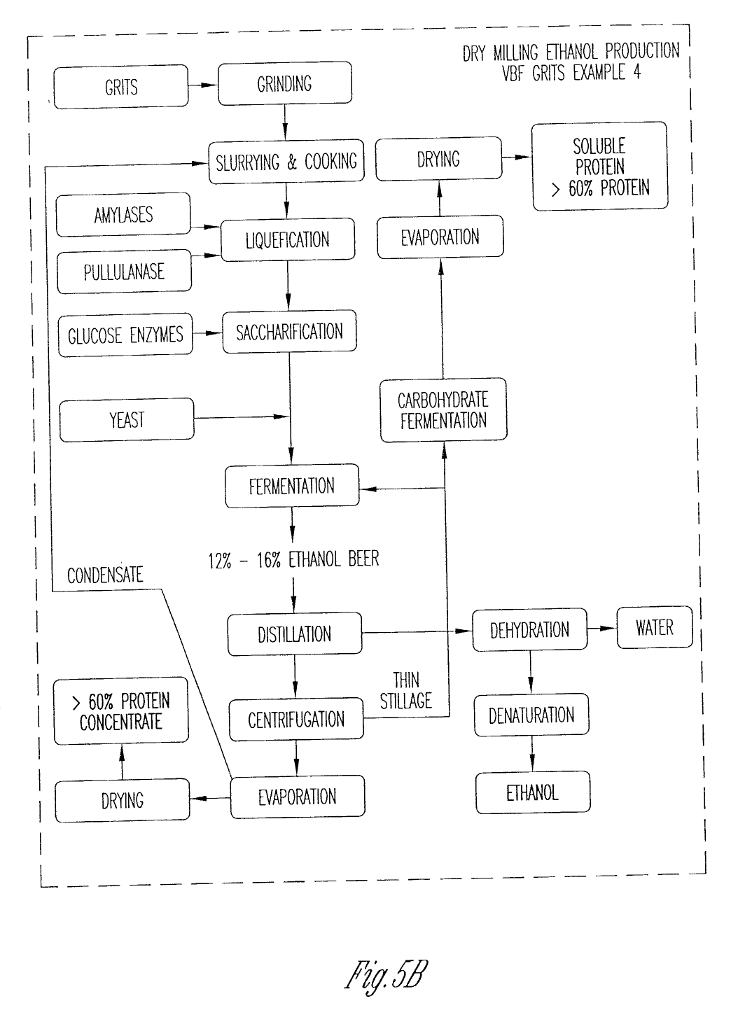

In VBF Example 3 (FIG. 4a,b,c), the corn is tempered, and then passed through the VBF. The thrus are first subjected to oil extraction, and then to ethanol fermentation. The grit portion follows the same pattern as before generating ethanol and a high protein concentrate.

### Example 4

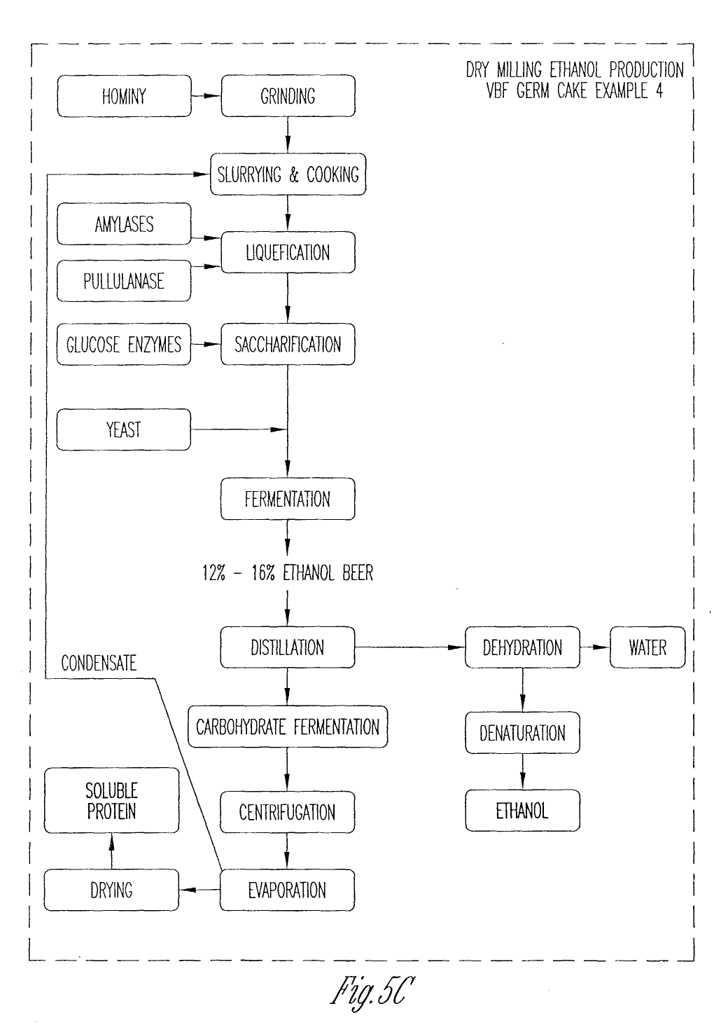

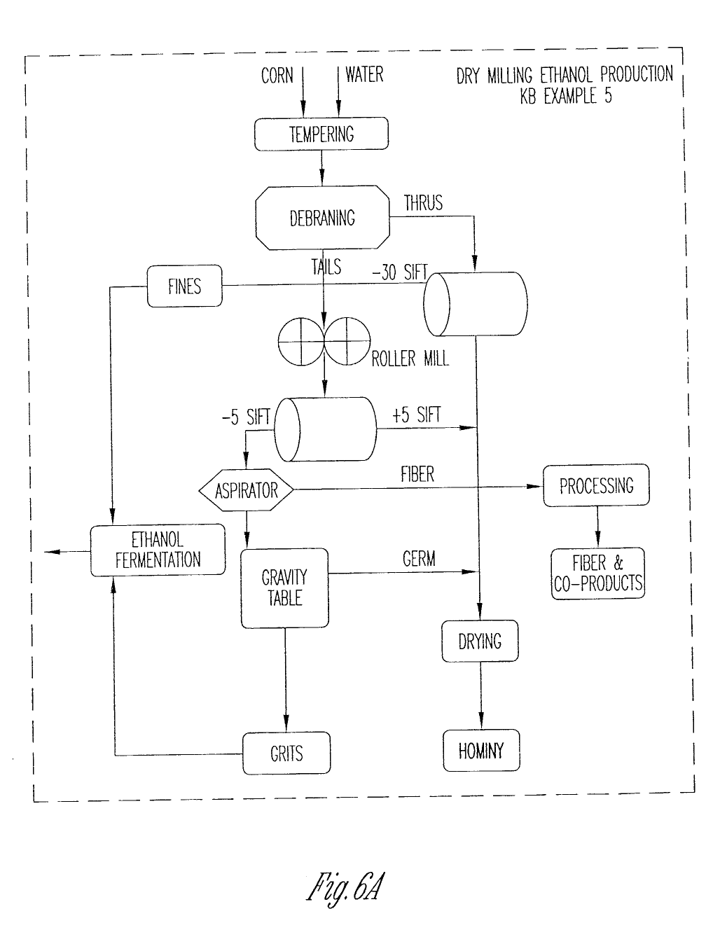

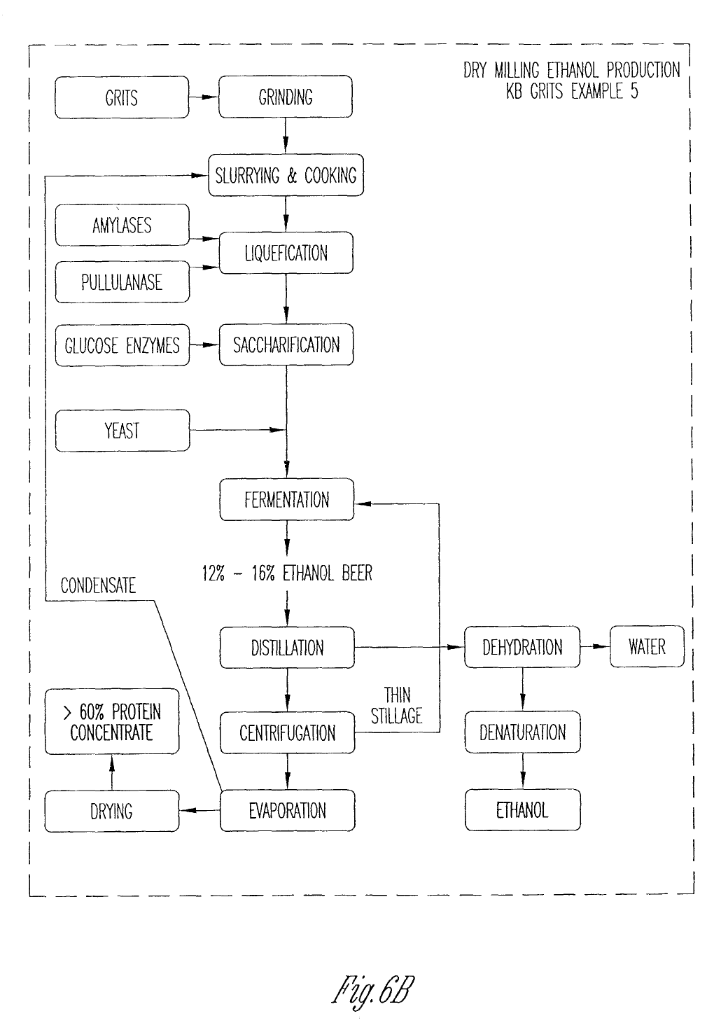

In VBF Example 4 (FIG. 5a,b,c), the corn is tempered, and then passed through the VBF. The thrus are subjected to oil extraction with the spent material being screened and aspirated for the fiber which will be used for DDGS. The rest of the material is directed towards ethanol fermentation. The grit portion follows the same pattern as before generating ethanol and a high protein concentrate and a soluble protein concentrate. Several co-products are adding value to the process.

### Satake KB

The value of separating out the fiber portion has several implications. First, by removing it prior to fermentation it helps increase fermenter capacity and efficiency, second, it can be further processed to develop potential products as corn fiber gum, corn fiber oil, L-arabinose, polyamine conjugates, cellulose/arabinoxylan products, fuel ethanol, and to make hominy, or third, it can be used to generate phytosterols. While structurally similar to cholesterol, phytosterols work to reduce the serum level of low-density lipoprotein (LDL) cholesterol, which is associated with atherosclerosis. The effects of phytosterols on cholesterol reduction have been documented for nearly 50 years, but only recently have they found application to food products.

Corn fiber oil has been reported to contain high levels of three potential cholesterol-lowering phytosterol components: ferulate-phytosterol esters (FPE), free phytosterols, and phytosterol-fatty acyl esters. Corn fiber is a pericarp-enriched fraction obtained by the wet milling of corn, whereas corn bran is a pericarp-enriched fraction obtained by the dry milling of corn. It has been found that the levels of FPE are much higher in corn fiber oil than in corn bran oil. It appears that only in wet milling are most of the FPE (94%) recovered in the fiber. In contrast, during dry milling only 18% of the FPE are localized in the bran and 81% are in the grits.

The present embodiments of the invention, utilizing dry milling equipment, especially the KB machine, indicates that a procedure that isolates a fraction that does have a high concentration of FPE. The practice of the embodiments of this invention result in, a dry milled fraction (KB thrus lifts, −24) that yields 49.2 mg of FPE/100 g dry wt. verses 27.58 mg of FPE from a wet milled fiber fraction from a commercial run.

The embodiment of the next four examples described depend upon placing a Satake KB Rice Polisher at the beginning of the ethanol process.

### Example 5

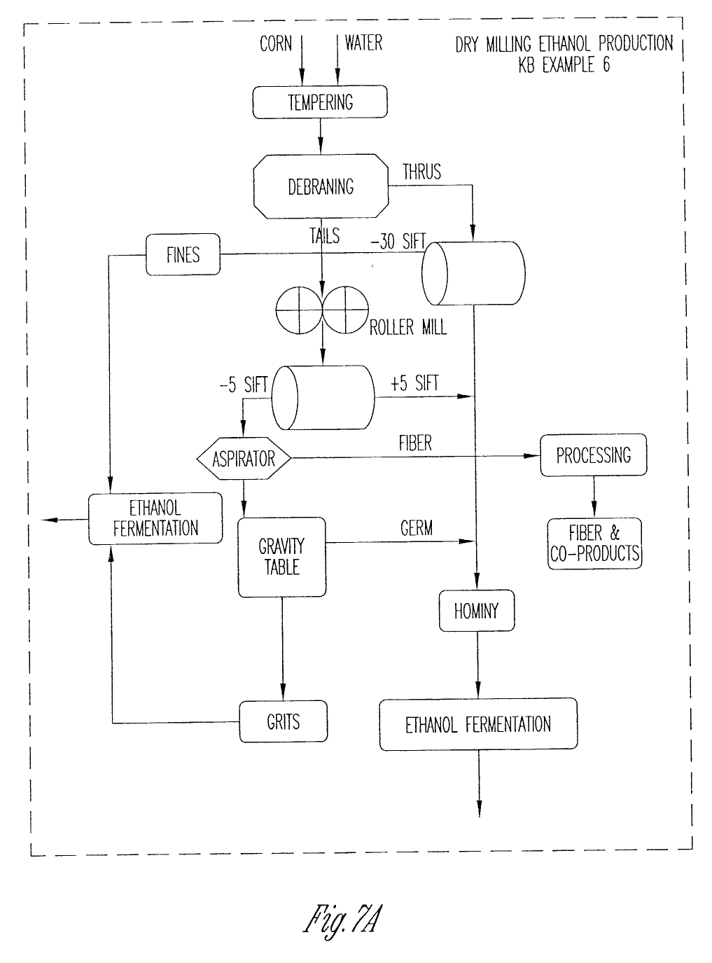

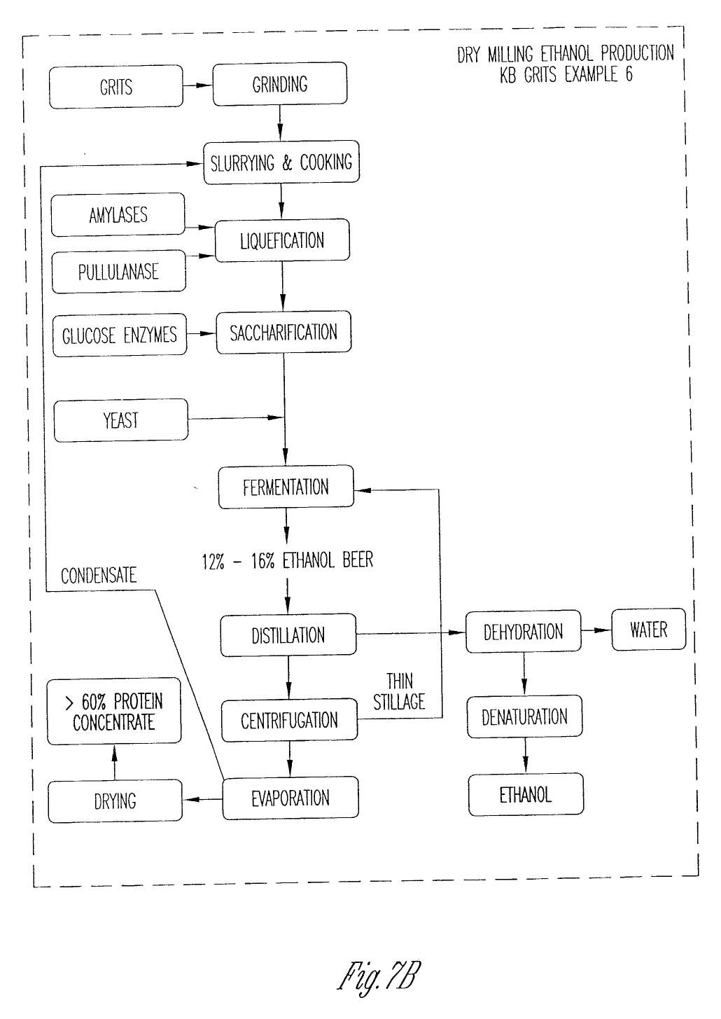

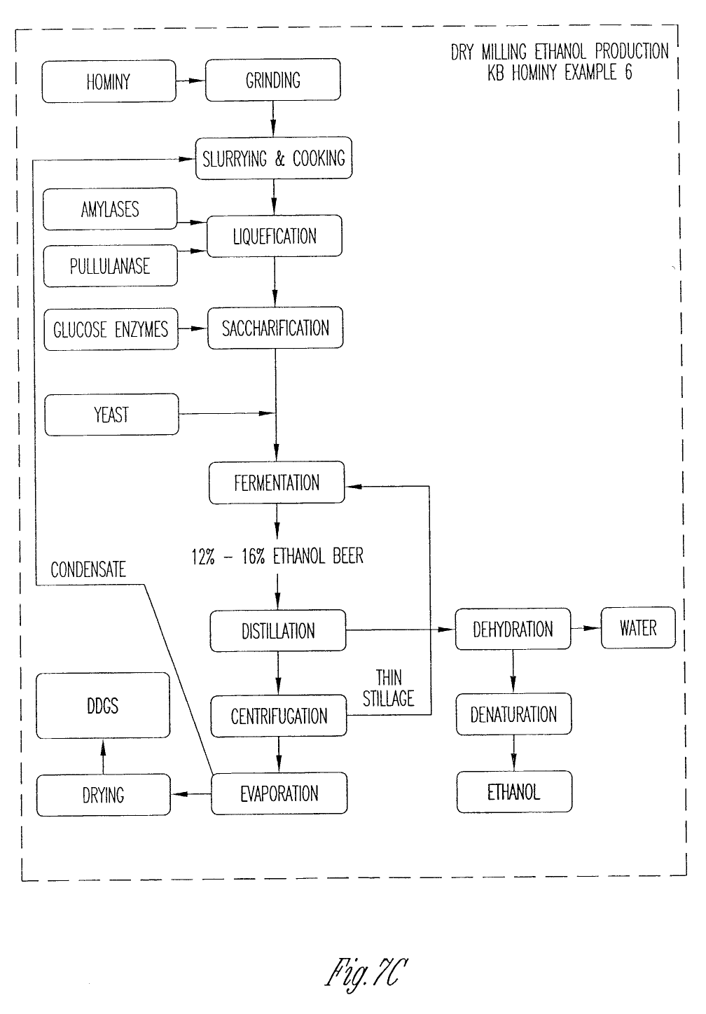

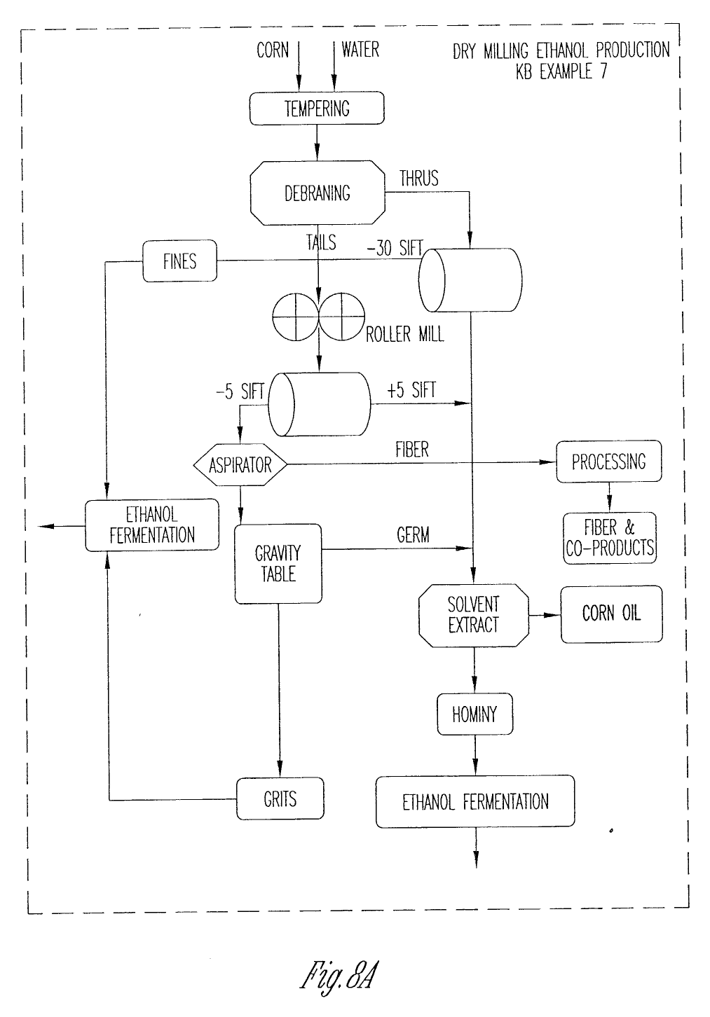

In KB Example 5 (FIG. 6a,b), the corn is tempered with water, and then passed through the KB debraning machine. The resulting thrus (pericarp+starch) are screened with the fines going to ethanol production and the fiber is dried and used for hominy. The tails (endosperm+embryo+attached pericarp) are passed through a roller mill, then sifted through a screen (size 5), followed by an aspirator and gravity table (FIG. 6a). The fiber and germ portions end up in hominy and the grits go into production of ethanol and the high protein concentrate (60% Protein Concentrate).

### Example 6

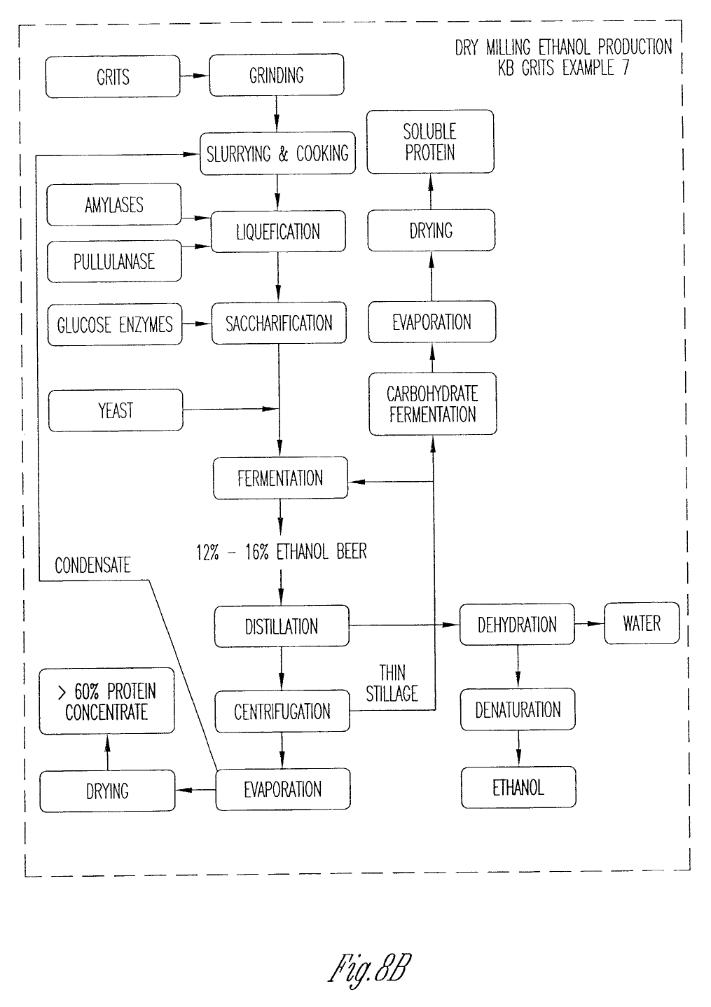

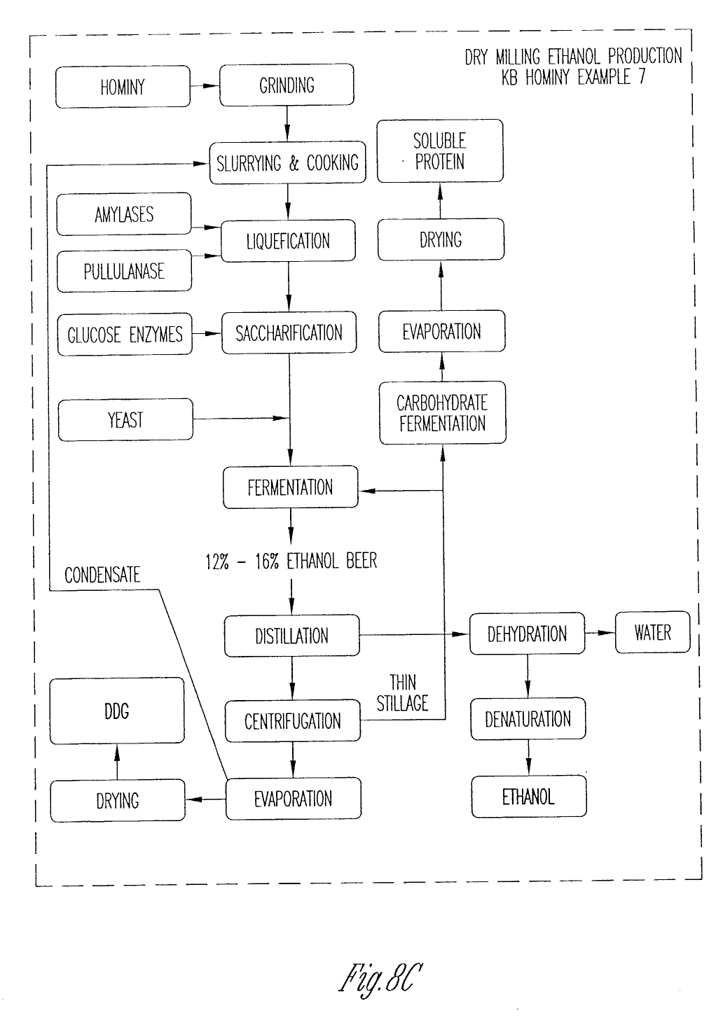

In KB Example 6 (FIG. 7a,b,c), the grain is treated similarly to the previous KB Example 1, except that the hominy is converted to ethanol by a secondary fermentation.

### Example 7

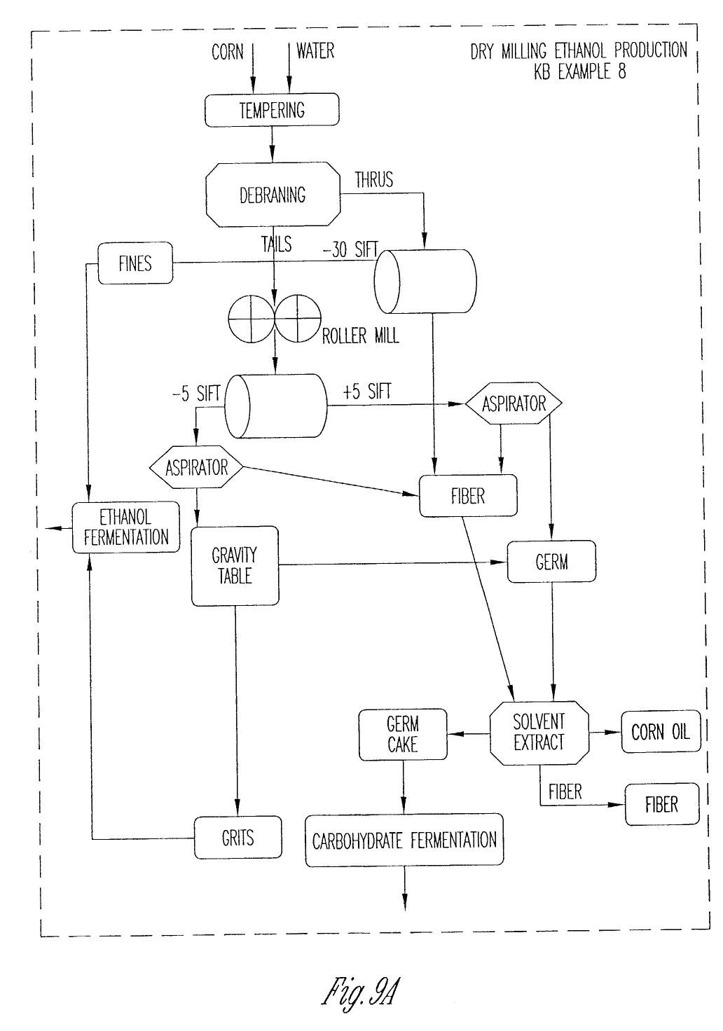

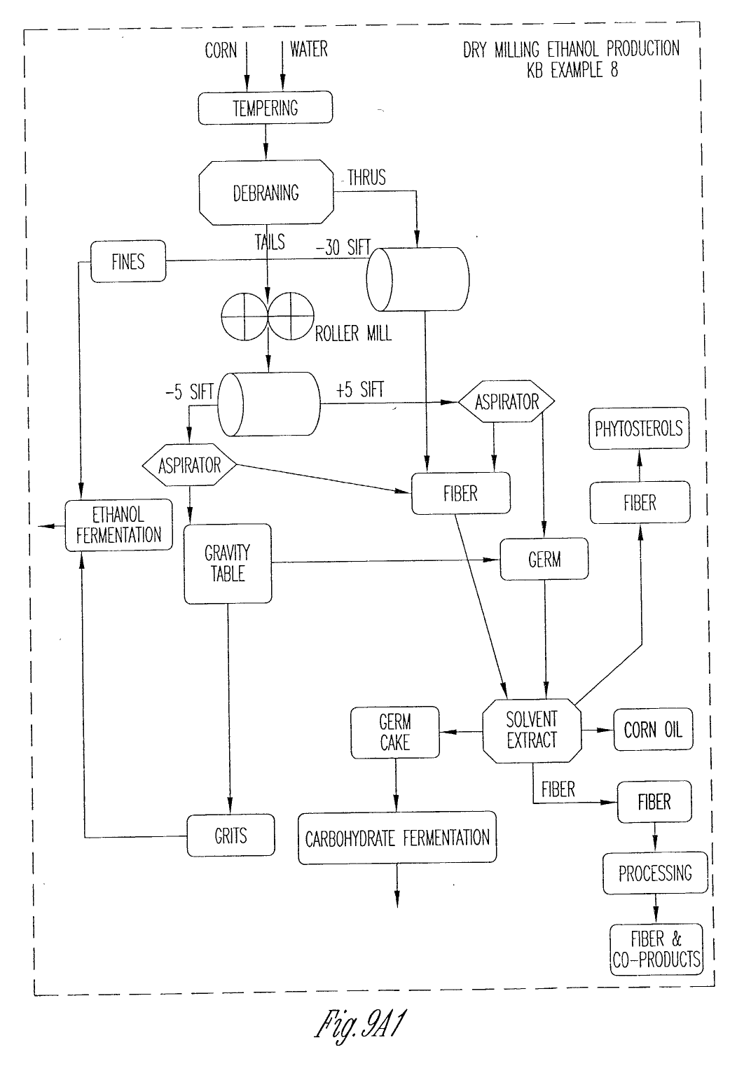

In KB Example 7 (FIG. 8a,b,c), the corn is tempered, and passed through the KB as in Example 1 and 2. However, in this example, the thrus from the sifting screen, aspirator, and gravity table are collected for solvent extraction of the oil, and the remaining spent material is taken forward to ethanol fermentation. Consequently, the material balance for this example adds the value of oil to the existing ethanol, DDGS, and high protein products.

### Example 8

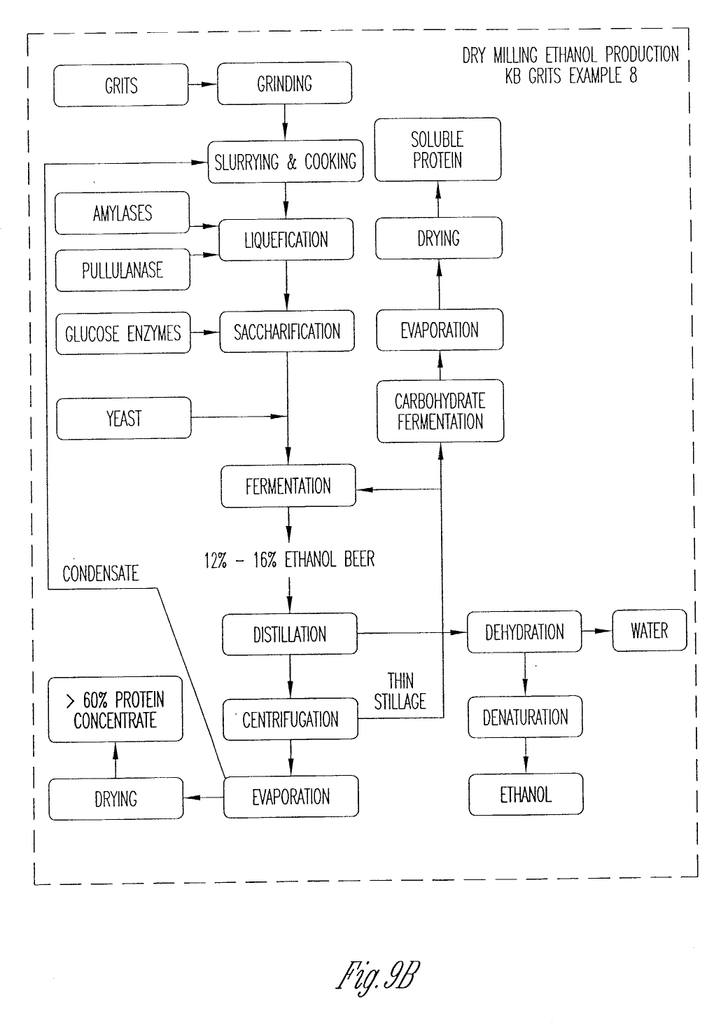

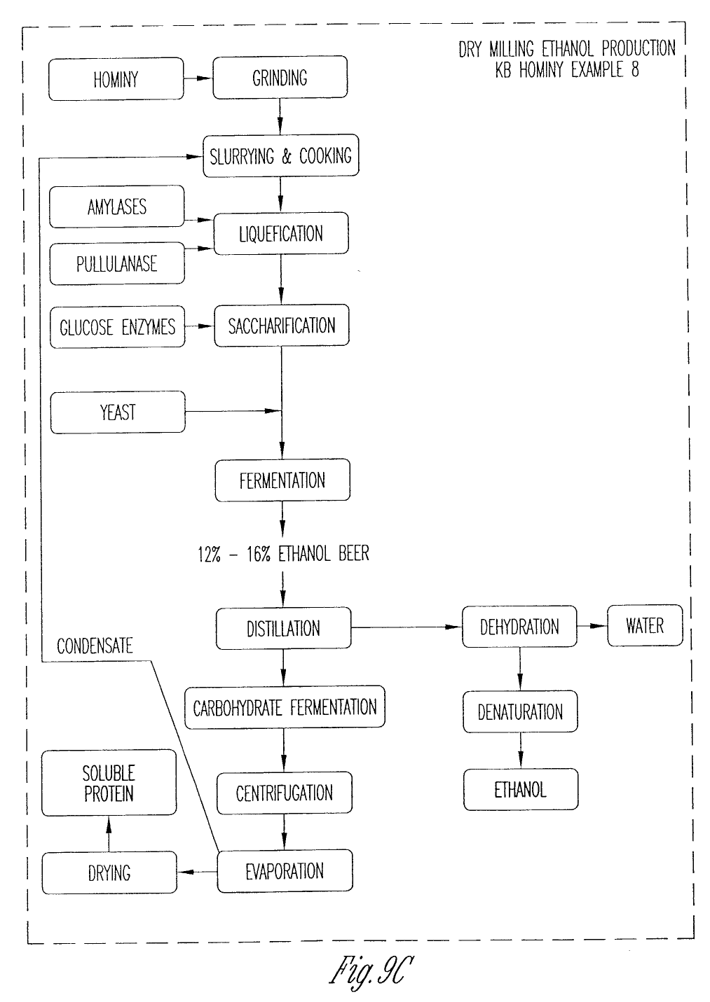

In KB Example 4 (FIG. 9a,b,c), the corn is tempered with water, and then passed through the KB machine. In this system, corn oil is extracted from the fiber and germ, and the fiber is saved as a separate entity. The grits follow the usual course of producing ethanol and a high protein concentrate. The hominy is directed towards ethanol and soluble protein end products.

The incorporation of dry milling equipment is considerably more economical to implement than setting up a wet mill system to separate the corn kernel into parts before processing.

The development and implementation that the present invention offers has the potential to explore the potential to increase the commercialization of extracting phytosterols from the fiber fractions which are possible depending upon which example is used in production.

As can be seen from the foregoing, the invention accomplishes at least all of its objectives.

While there has been described what is at present considered the specific embodiments of the invention, it will be understood the various alternatives, modifications, and variations may be made therein, and will be apparent to those skilled in the art in light of the foregoing description, and it is intended to cover in the appended claims all such modifications as falls within the true spirits and scope of the invention.

### BIBLIOGRAPHY

Chang D., M. P. Hojilla-Evangelista, L. A. Johnson and D. J. Myers. 1995. Economic-engineering assessment of sequential extraction processing of corn. Trans ASAE 38:1129-1138.

Earle, F. R., Curtis, J. J., and Hubbard, J. E. 1946. Composition of the component parts of the corn kernel. Cereal Chem. 23:504-511.

Hamilton, T. S., Hamilton, B. C., Johnson, B. C., and Mitchell, H. H. 1951. The dependence of the physical and chemical composition of the corn kernel on soil fertility and cropping systems. Cereal Chem. 28:163-176.

Hojilla-Evangelista, M. P., D. J. Myers and L. A. Johnson. 1992a. Characterization of protein extracted from flaked, defatted, whole corn by the sequential extraction process. J. Amer. Oil. Chem. Soc. 69:199-204.

Moreau, R. A., Singh, V., Eckhoff, S. R., Powell, M. J., Hicks, K. B., and Norton, R. A. 1999. Comparison of yield composition of oil extracted from corn fiber and corn bran. Cereal Chem. 76:449-451.

Myers, D. J., M. P. Hojilla-Evangelista and L. A. Johnson. 1994. Functional properties of protein extracted from flaked, defatted, whole corn by ethanol/alkali during sequential extraction process. J. Amer. Oil. Chem. Soc. 71:1201-1204.

Nelson, T. S., Ferrara, L. W., and Storer, N. L. 1968. Phytate phosphorus content of feed ingredients derived from plants. Poult. Sci. 47:1372-1374.

Neuffer, M. G., Jones, L. and Zuber, M. S. 1968. The Mutants of Maize. Crop Sci. So. Am., Madison, Wisc., 74 pp.

O'Dell, B. L., de Boland, A. R., and Koirtyohann, S. R. 1972. Distribution of phytate and nutritionally important elements among morphological components of cereal grains. J. Agric. Food Chem. 20:718-721.

Sagiura, S. H. et al. 1998. Apparent protein digestibility and mineral availabilities in various feed ingredients for salmonid feeds. Aquaculture 159:177-202.

Singh, V. 1998. The feasibility and profitability of the “quick germ” process for ethanol production from corn. Ph.D. Thesis. University of Illinois at Urbana-Champaign. Urbana, Ill.

Singh, V. and Eckhoff, S. R. 1997. Economics of germ preseparation for dry grind ethanol facilities. Cereal Chem. 74:462-466.

Skonberg, D. I., Hardy, R. W., Barrows, F. T., and Doug, F. M. 1998. Color and flavor analysis of the fillet from farm-raised rainbow trout (oncorhynchus mykin) fed low phosphorus feeds containing corn or wheat gluten. Aquaculture 166:1269-277.

Wahjudi, J., Xu, L., Wang, P., Singh V., Buriak, P., Rausch, K. D., McAloon, A. J., Tumbleson, M. E., and Eckhoff, S. R. 2000. The quick fiber process: effect of mach temperature, dry solids and residual germ on fiber yield and purity. Cereal Chem. 77:640-644.

Weede, N. 1997. Low phosphorus plant protein ingredients in finishing diets for rainbow trout (oncorhynchus mykin). M. S. Thesis, University of Washington, Seattle, 147 pp.

Wolf, M. J., Buzan, C. L., MacMasters, M. M., and Rist, C. E. 1952a. Structure of the mature corn kernel. I. Gross anatomy and structural relationships. Cereal Chem. 29:321-333.

Wu, Y. V., K. R. Sexson, and A. A. Lagoda. 1985. Protein-rich alcohol fermentation residues from corn dry-milled fractions. Cereal Chem. 62(6):470-473.

What is claimed is:

1. A highly-digestible, high protein concentrate for feeding operations obtained by a modified method of dry milling corn using specific dry milling at the beginning of the ethanol process comprising more than 60% protein content.

2. The high protein concentrate of claim 1 preferably comprising up to about 80% protein content.

3. The high protein concentrate of claim 2 having more preferably from about 40% to about 65% protein content.

4. The high protein concentrate of claim 1 further comprising an oil content in the range of about 4% to about 6%.

5. The high protein concentrate of claim 1 further comprising a starch content of about less than 1%.

6. The high protein concentrate of claim 1 further comprising acid detergent from about 2% to about 3%.

7. The high protein concentrate of claim 6 wherein the acid detergent is preferably from about 1.5% to about 2.5%.

8. The high protein concentrate of claim 1 further comprising a lysine value of about 1% to about 2%.

9. The high protein concentrate of claim 8 wherein the lysine value is preferably from about 1% to about 1.75%.

10. The high protein concentrate of claim 1 further comprising a xanthophyll content of less than about 80mg/kg.

11. The high protein concentrate of claim 1 further comprising a beta-carotene content of less than about 3 mg/kg.

12. The high protein concentrate of claim 1 which is an animal feed.

13. The high protein concentrate of claim 1 which is a fish feed.

14. The high protein concentrate of claim 1 wherein the animal feeding operations is for a monogastric animal.

15. A process for producing a high protein concentrate for feeding operations derived from a modified version of dry milling corn comprising:
tempering corn;
passing corn through a milling machine;
collecting fractions of corn;
directing the thrus into a product stream; and
directing the grits into a separate product stream.

16. The process of claim 15 wherein the corn is yellow and white corn.

17. The process of claim 15 further comprising drying the thrns.

18. The process of claim 15 wherein the thrus is used to form hominy.

19. The process of claim 15 further comprising grinding and fermenting the grits in order to produce ethanol and a high protein concentrate.

20. The process of claim 15 wherein the milling machine is a maize degermer.

21. A process for producing a high protein concentrate for feeding operations derived from a modified version of dry milling corn comprising:
tempering corn;
passing corn through a milling equipment;
collecting fractions of corn;
directing the thrus to a secondary fermentation unit in order to produce alcohol;
directing the grits into a separate product stream to grind and ferment in order to produce ethanol and a high protein concentrate.

22. The process of claim 21 wherein the corn is yellow and white corn.

23. A high protein concentrate prepared in accordance with the process of claim 21.

24. A process of claim 21 wherein the milling machine is a maize degermer.

25. A process for producing a high protein concentrate for feeding operations derived from a modified version of dry milling corn comprising:
tempering corn;
passing corn through a milling machine;
collecting fractions of corn;
directing the thrus into a product stream for oil extraction and then to ethanol fermentation; and
directing the grits into a separate product stream to grind and ferment in order to produce ethanol and a high protein concentrate.

26. The process of claim 25 wherein the corn is yellow and white corn.

27. A process of claim 25 wherein the milling machine is a maize degermer.

28. A high protein concentrate for feeding operations prepared in accordance to the process of claim 25.

29. A process for producing a high protein concentrate for feeding operations derived from a modified version of dry milling corn comprising:
tempering corn;
passing corn through a milling machine;
collecting fractions of corn;
directing the thrus into a product stream for oil extraction, with the spent material being screened and aspirated for the fiber to be used for DDGS; and
directing the grits into a separate product stream to grind and ferment in order to produce ethanol and a high protein concentrate.

30. The process of claim 29 wherein the corn is yellow and white corn.

31. A high protein concentrate for feeding operations prepared in accordance to the process of claim 29.

32. A process of claim 29 wherein the milling machine is a maize degermer.

33. A process for producing a high protein concentrate for feeding operations derived from a modified version of dry milling corn comprising:
tempering the corn;
passing the corn through a debraning machine;
screening the thrus; and
passing the tails through a roller mill.

34. The process of claim 33 further comprising directing fines to ethanol production.

35. The process of claim 33 further comprising drying fiber to be used for hominy.

36. The process of claim 33 further comprising sifting the tails through a screen followed by an aspirator and a gravity table.

37. The process of claim 33 wherein a germ portion is used for hominy and a grit portion is used for production of ethanol and a high protein concentrate.

38. The process of claim 36 where the screen is a size 5.

39. The process of claim 33 wherein the corn is yellow and white corn.

40. A high protein concentrate for feeding operations prepared in accordance with claim 33.

41. The process of claim 33 wherein the debraning machine is a rice polisher.

42. The process of claim 33 wherein the hominy is converted to ethanol by a secondary fermentation.

43. A process for producing a high protein concentrate for feeding operations derived from a modified version of dry milling corn comprising:
tempering the corn;
passing the corn through a debraning machine;
directing the thrus into a product stream; and
directing the grits into a separate product stream.

44. The process of claim 43 further comprising passing the tails through a roller mill, sifting through a screen, followed by an aspirator and a gravity table.

45. The process of claim 43 wherein the fines from the thrus are used for ethanol production.

46. The process of claim 43 further comprising drying fiber to be used for hominy.

47. The process of claim 43 further comprising directing the hominy to a secondary fermentation for ethanol production.

48. The process of claim 43 wherein a germ portion is used for hominy and a grit portion is used for production of ethanol and a high protein concentrate.

49. The process of claim 44 where the screen is a size 5.

50. The process of claim 43 wherein the corn is yellow and white corn.

51. The process of claim 43 wherein the thrus from the sifting screen, aspirator, and gravity table are collected for solvent extraction of oil.

52. The process of claim 43 wherein the debraning machine is a rice polisher.

53. The process of claim 43 wherein remaining spent material is directed to ethanol fermentation.

54. A high protein concentrate for feeding operations prepared in accordance with claim 43.

55. A process for producing a high protein concentrate for feeding operations derived from a modified version of dry milling corn comprising:
tempering the corn;
passing the corn through a debraning machine;
extracting corn oil from the fiber and germ.

56. The process of claim 53 wherein the corn is yellow and white corn.

57. The process of claim 53 further comprising saving the fiber as a separate entity.

58. The process of claim 55 further comprising directing a grit fraction to produce ethanol and a high protein concentrate.

59. A high protein concentrate for feeding operations prepared in accordance with claim 55.
